(19) United States
(12) Patent Application Publication
(10) Pub. No.: US 2005/0214182 A1
(43) Pub. Date: Sep. 29, 2005

(54) Small ozone generator module

(75) Inventor: De Fa Lu, Zhonghe City (TW)

Correspondence Address: DAVID E. DOUGHERTY;Dennison, Schultz & Dougherty, Suite 105, 1727 King Street, Alexandria, VA, 22314-2700, US

(73) Assignee: HONG CHI TECHNOLOGY CO., LTD.

(21) Appl. No.: 10/806,384

(22) Filed: Mar. 23, 2004

(51) Int. Cl. B01J 19/08

(52) U.S. Cl. 422/186.07

(57) ABSTRACT

This invention is a type of ozone generator module whose circuit board is contained in a small shell-shaped box, which is connected to an external power supply through wires extending from the body of the box. The interior of this insulated box is covered in a layer of resin that surrounds and insulates (electric and heat) the circuit board. This allows the components necessary in the production of the ozone gas (such as the electrode pins and electrode board needed for point diffusion, or the ultraviolet light tube or ceramic parts necessary for ozone generation by the ultraviolet light method) to produce and diffuse ozone gas outside the body of the box. This allows the ozone generator to meet the requirements for its downscaling and modulation, and allows the broadening of its application range.

### BACKGROUND OF THE INVENTION

The invention relates to a small ozone generator module, and is more particularly to place in a shell-shaped insulated box.

This invention is a small ozone generator module. This refers to a circuit board that is placed in a shell-shaped insulated box that is covered internally in a layer of insulation resin that surrounds the circuit board, such that the ozone occurs outside the resin layer, and the ozone generator is reduced in size and modulated. This can help to broaden the use of the ozone, as well as simplify application designs.

Generally, ozone is a gas that has multiple functions, such as disinfecting sterilizing, cleaning the air, etc, and is thus widely used in products of all kinds, such as in air purifiers that use its high oxygenation to disinfect toxins in the air. Ozone is also used in water dispensers, shoe cabinets, etc. to disinfect or deodorize; it can be dissolved in water, and be used to clean fruit breaking down the residual pesticides. Moreover, various recent lifestyle oriented products, such as PDA (Personal Digital Assistant), cell phones, or computer input devices (such as mouses or keyboards) are focused on a lighter, thinner, shorter, or smaller design to increase their convenience of use. Unfortunately, the ozone generators currently being used are bulky, complicated device. Although the large size of these devices can increase their efficiency, their applications in everyday life are severely limited. Many products have sadly been unable to effectively integrate with ozone generation, or develop disinfecting or air cleansing functions. Thus, there exists a demand for a small ozone generator module; this invention addresses that demand.

### SUMMARY OF THE INVENTION

In one aspect, the present invention is directly to designs for a small ozone generator module. This refers to an ozone generator that has been scaled down and modulated, as to increase the applications of ozone, as well as its ease of use.

In one embodiment, the present invention is to provide designs for a small ozone generator module whose circuit board is housed in a shell-shaped insulated box. The power cords of the ozone generator extend out of the box, and the interior of the box is covered in an insulation resin that covers and insulates the circuit board such that the electrode pins and opposite electrode board structure required by the through point discharge production of the ozone or the ultraviolet light tube structure required by the ultraviolet light production method can extend outside of the resin. The ozone gas is then generated outside the box, and dispelled outward.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a 3D view of the first embodiment of the present invention;

FIG. 2 is a top elevation view of FIG. 1;

FIG. 3 is a sectional view of FIG. 1;

FIG. 4 is a circuit diagram of FIG. 1;

FIG. 5 is a 3D view of the second embodiment of this present invention;

FIG. 6 is a top view of FIG. 5;

FIG. 7 is a sectional view of FIG. 5;

FIG. 8 is a 3D view of the third embodiment of this present invention;

FIG. 9 is a sectional view of FIG. 8;

FIG. 10 is a top view of FIG. 8;

FIG. 11 is a circuit diagram of the ozone generator module of FIG. 8.

### DETAILED DESCRIPTION OF THE PREFERRED EMBODIMENTS

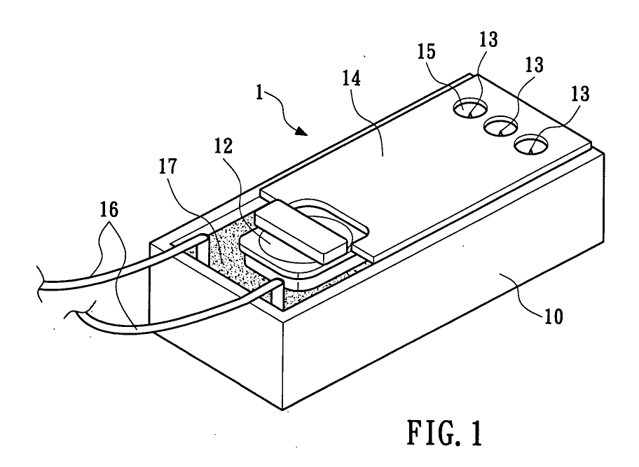

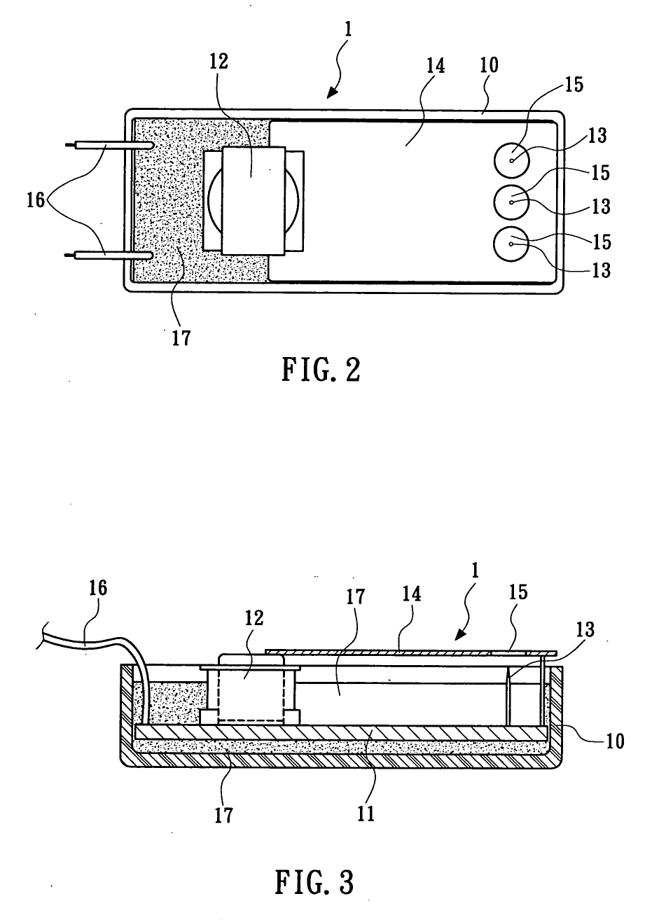

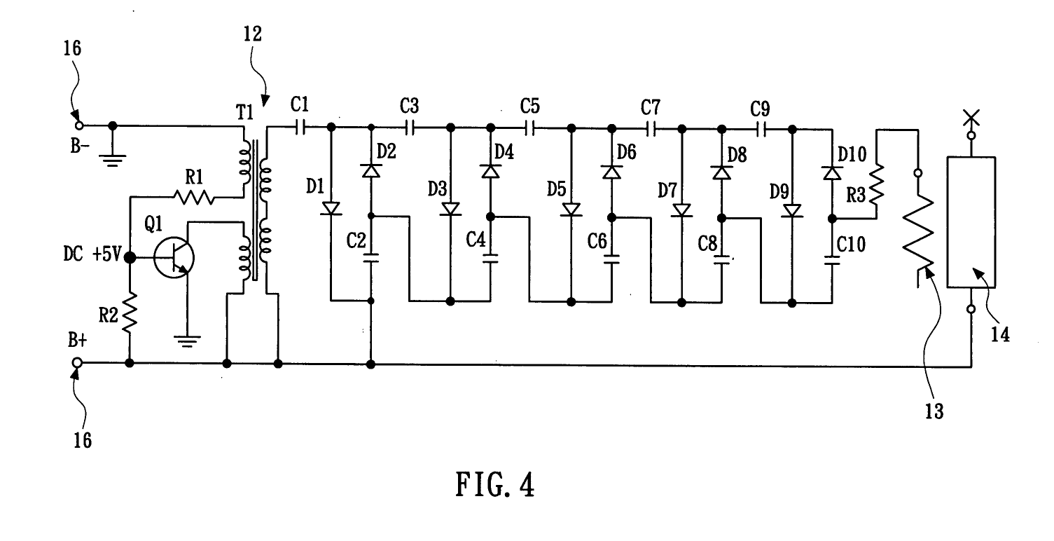

As shown in FIGS. 1, 2, 3, and 4, an ozone generator module 1 generally designated by the reference includes a shell-shaped insulated box 10, the shape of which is not important (can be rectangular, square, cylindrical, etc.). As shown in FIG. 1, the box 10 is a rectangular shape, and can at least be kept as small as 43 mm (L)×18 mm (W)×11.5 mm (H), and has an open rectangular face on one of its sides. There is a circuit board 11 installed at the bottom portion of the box 10. On the circuit board 11, there is a small transformer 12 that can convert the low voltage power input to high voltage, low current, and is connecting several electrode pins 13 upward to an electrode board 14 with opposing electrodes. The electrode pins 13 and electrode board 14 are located on the open face of the box 10, and there are holes 15 on the electrode board 14 that line up exactly with the tip of each electrode 13. The circuit board 11 also has two negative and positive wires 16 that connect with the exterior power source (if used in a mouse, it can be connected to the power from the USB (Universal Serial Bus) plug). The input power of the negative and positive wires can vary within 5-12 volts to enable the ozone generator to produce ozone gas. The interior of the box 10 is covered with a layer of resin 17 (such as Epoxy) to cover and insulate the circuit board 11. The upper portion of the resin 17 is located underneath the electrode board 14, such that the tips of the electrode pins 13 and electrode board 14 extend outside the resin, and box 10 can produce ozone from its outside. During use, the point diffusion occurs from the high voltage on the electrode pins 13, and a surge is produced between the holes 14 on the electrode board, such that ionization occurs in the surrounding air, and the oxygen molecules take on an extra anion, and become ozone gas. Additional negatively charged ions can be produced from the point diffusion shown in FIG. 4, thus causing the ion effect, which is beneficial to the human body.

In the first preferred embodiment of the present invention includes a circuit board 11, electrode pins 13, electrode board 14, which are located in a box 10 that has been insulated (for electricity and heat) with a layer of resin, such that it forms a ozone generator module), one can effectively reduce the overall volume of the ozone generator. Therefore, this invention can easily be applied to other items, thus increasing the range of products utilizing ozone generators.

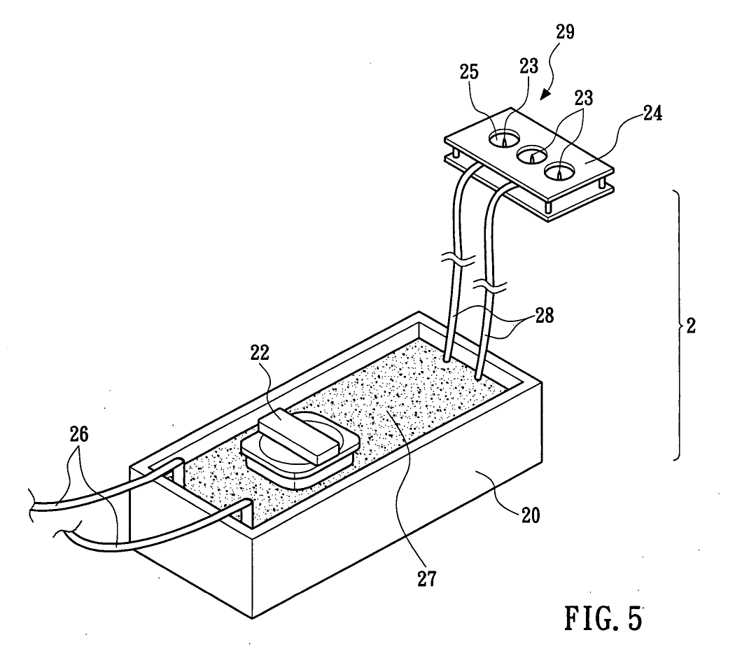

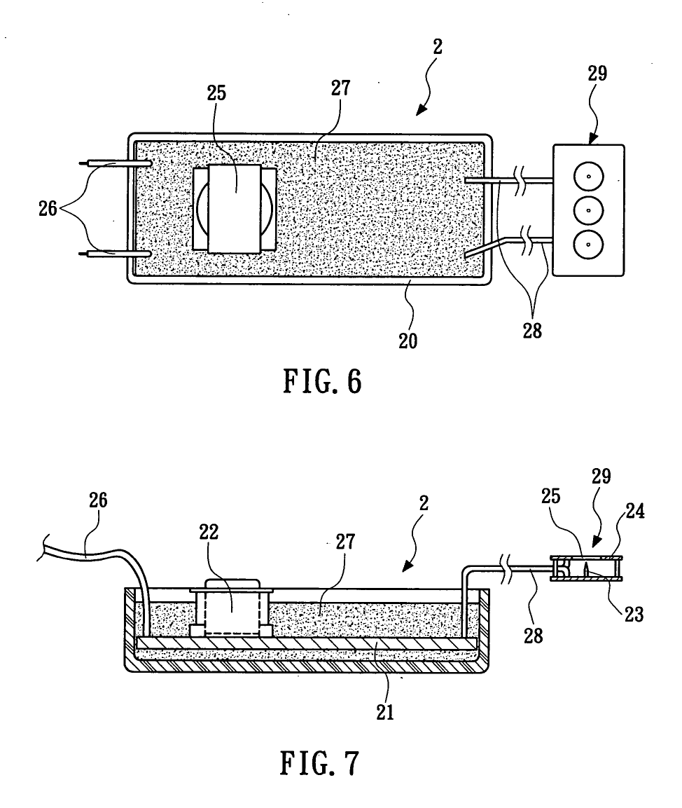

In a second embodiment of the present invention, as shown in FIGS. 5, 6, and 7, this invention is another type of small ozone generator module 2 that includes a shell-shaped insulated box 20, whose physical design can vary. In FIG. 5, the box 20 is a rectangular shape that can at least be kept as small as 43 mm (L)×18 mm (W)×11.5 mm (H), and has an open rectangular face on one of its sides. There is a circuit board 11 installed at the bottom portion of the box 21 (FIG. 4 can be used as reference for its circuitry). On the circuit board 21, there is a small transformer 22 that can convert the low voltage power input to high voltage, low current. This circuit board 21 is connected to two negative and positive wires 28, the ends of which are connected to a structure 29 composed of several electrode pins 23 and an electrode board 24. The electrode pins 23 and electrode board 24 have opposing electrodes. Also, the holes on the electrode board (24) are lined up exactly with the tips of the electrode pins 23. The difference between ozone generator modules 1 and 2 is that the electrode pins 13 and electrode board 14 of ozone generator module 1 are fixed on the open side of the box 10, whereas the electrode pins 23 and electrode board 24 of ozone generator 2 form a connected structure 29, and the structure can change its position due to the extension wires 28. Thus, ozone generator module 2 allows for convenience of choice in the location of the ozone generator (the location of the connected structure 29). In addition, the electrode board 21 of ozone generator module 2 has two negative and positive wires 26 that can connect to a power supply, such as direct connection to the USB plug power supply if used in mouses; the input power of the negative and positive wires can vary between 5˜12 volts to allow the ozone generator to produce ozone gas. In addition, the insulated box 20 is covered with a layer of resin 27, such as Epoxy, that covers and insulates (from electricity and heat) the circuit board 21. At the same time, point diffusion occurs as the electrode pins 23 in the connected structure 29 are introduced to high voltage, thus causing a surge between the opposing electrodes in the holes 24 of the electrode board 24, and producing ionization in the surrounding air. This ionization causes the oxygen molecules to take on an extra anion to become ozone gas. Using the above structure, the overall volume of the ozone generator module 2 can be reduced, thus allowing it to be easily used in other items, and increasing the range of its application. Additional negatively charged ions can be produced from the point diffusion shown in the ozone generator module 2 in FIG. 4, thus causing the ion effect, which is beneficial to the human body.

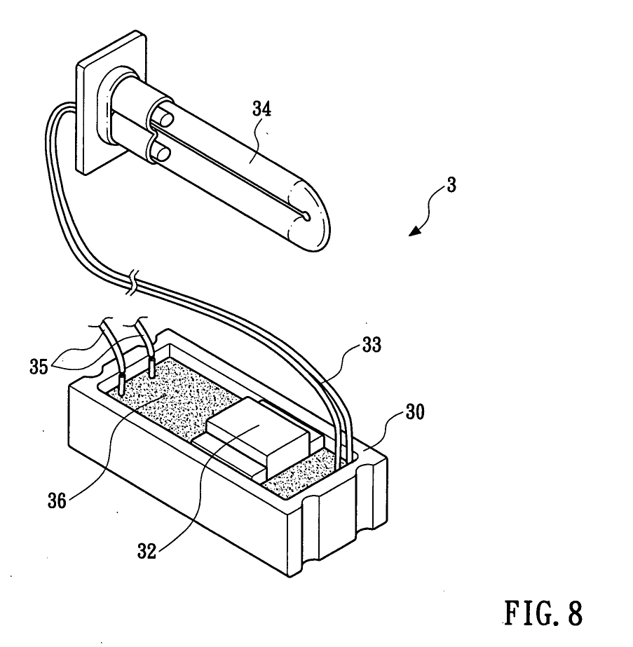

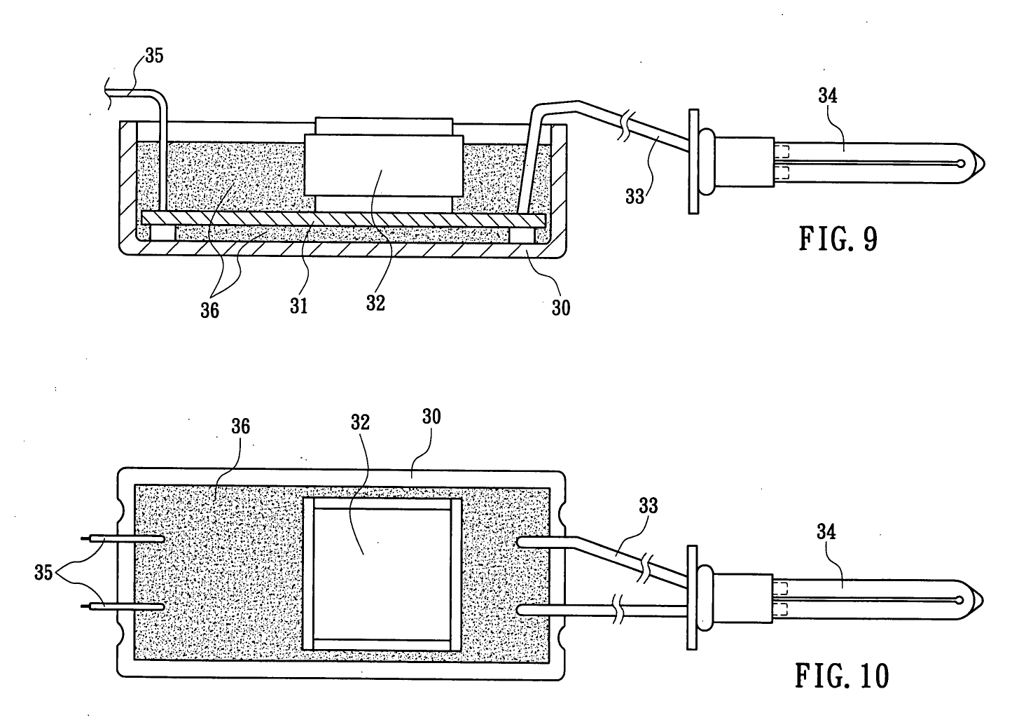

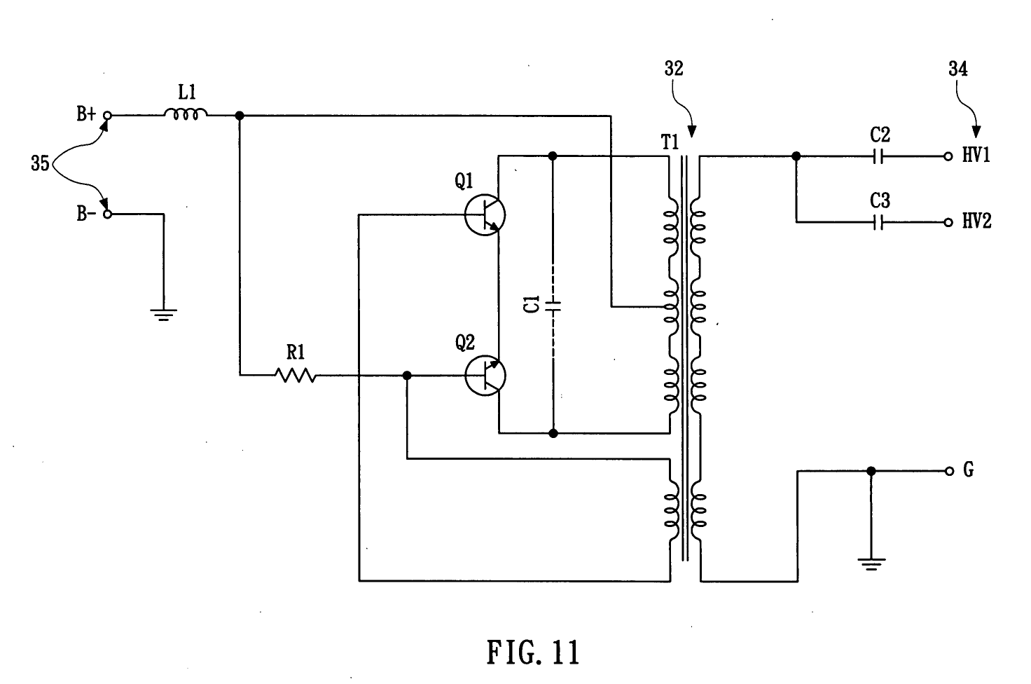

In a third embodiment of this present invention, as shown in FIGS. 8, 9, 10, and 11, the structure of ozone generator module 3 utilizes an ultraviolet light tube to produce ozone gas. This includes a shell-shaped insulated box 3, the shape of which may vary. The exterior of the rectangular shaped box 30 shown in FIG. 8 can be kept at least as small as 50 mm (L)×25 mm (W)×20 mm (H), and has an open rectangular face on one of its sides. A circuit board 31 is located near the bottom of the box's 30 interior, and a transformer 32 is attached onto the circuit board 31, as to convert the originally low voltage mouses to high voltage, low current. In addition, two positive and negative wires 33 are connected outward from the circuit board 31 to an ultraviolet light tube 34. The circuit board also has tow positive and negative wires that connect to an external power source (such as directly connecting to a USB plug power supply in mouses); the input power of the positive and negative wires 35 can vary within 5˜12 volts to allow the ozone generator to produce ozone gas. In addition, the interior of the insulated box 30 is covered in a layer of resin 36, such as Epoxy, that covers and insulates (electric and heat) the circuit board. The above structure allows the volume of the ozone generator module 3 to be reduced, allowing it to be easily installed in the receiver or recharger outlet of cordless mouses. During use, point diffusion occurs in the ultraviolet light tube 34, thus continually producing ozone gas from the outside of the ultraviolet light tube 34. A small fan can also be installed in the receiver to blow air towards the ultraviolet light tube 34, as to effectively increase the amount of ozone gas produced.

In addition, the overall volume of the ozone generator module 3 can be reduced, thus allowing it to be easily used in other items (such as in the receiver or recharger outlet of cordless mouses), and increasing the range of its application. In addition, the ozone generator module 3 can also be used by replacing the ultraviolet light tube 34 with a ceramic tube, thus producing ozone gas using the ceramic tube.

While preferred embodiments have been shown and described, various modifications and substitutions may be made without departing form the spirit and scope of the invention. Accordingly, it is to be understood that the present invention has been described by way of example, and not by limitation.

1. A small ozone generator module comprising:
an insulated box having an open face on one of its sides;
a circuit board being used to generate ozone, being installed near the base of said insulated box;
a transistor installed on said circuit board changing a low input voltage to a high voltage with low current;
several electrode pins and an electrode board with opposing electrodes being each connected to said circuit board;
said electrode pins and said electrode board located on the open face of said box;
holes on said electrode board being lined up exactly with said each electrode pin, such that the center of each hole lining up with the point of said each electrode pin, thus facilitating ozone generation by point diffusion;
two positive and negative wires to connect to an outside power supply;
a layer of insulation resin applied on the interior of said box to surround said circuit board; and
the top of said layer of resin being located under said negative electrode board, such that the tips of said electrode pins and said electrode board being on the outside of said resin layer;

2. The small ozone generator module of claim 1, wherein said resin layer can use epoxy.

3. The small ozone generator module of claim 1, wherein said box can be rectangular.

4. The small ozone generator module of claim 3, wherein said box can be 43 mm (L)×18 mm (W)×11.5 mm (H) or smaller.

5. The small ozone generator module of claim 1, wherein said input of the positive and negative wires can vary within a range of 5˜12 volts.

6. A small ozone generator module comprising:
an insulated box having an open face on one of its sides;
a circuit board being used to generate ozone, and being installed near the base of said insulated box;
a transistor being installed on said circuit board changing a low input voltage to a high voltage with low current;
two positive and negative wires to be connected from said box to an external connected structure;
said connected structure being composed of several electrode pins and said electrode board with said opposing electrodes being each connected to the circuit board;
negative electrode holes on said electrode board being lined up exactly with each said electrode pin, such that the center of each said hole lining up with the point of each said electrode pin, thus facilitating ozone generation by point diffusion;
two positive and negative said wires connecting to an outside power supply; and
a layer of insulation resin applied on the interior of said box to surround said circuit board.

7. The small ozone generator module of claim 6, wherein said resin layer can use epoxy.

8. The small ozone generator module of claim 6, wherein the shape of said can be rectangular.

9. The small ozone generator module of claim 8, wherein the size of said can be 43 mm (L)×18 mm (W)×11.5 mm (H) or smaller.

10. The small ozone generator module of claim 6, wherein the input power of said positive and negative wires can vary within a range of 5˜12 volts.

11. A small ozone generator module comprising:
an insulated box having an open face on one of its sides;
a circuit board being used to generate ozone being installed near the base of said insulated box;
a transistor being installed on said circuit board changing a low input voltage to a high voltage with low current;
two positive and negative wires to be connected from said box to an external connected structure;
said connected structure being composed of several electrode pins and an electrode board with opposing electrodes being each connected to said circuit board;
negative electrode holes on said electrode board being lined up exactly with each said electrode pin, such that the center of each said hole lining up with the point of each said electrode pin, thus facilitating ozone generation by point diffusion;
tow said positive and negative wires being connected to said circuit board located near the base of said box to an ultraviolet light tube, for the purpose of generating ozone gas using the ultraviolet light tube;
two said positive and negative wires connecting to an outside power supply; and
a layer of insulation resin applied on the interior of the box to surround said circuit board.

12. The small ozone generator module of claim 11, wherein said resin layer can use epoxy.

13. The small ozone generator module of claim 11, wherein said box can be rectangular.

14. The small ozone generator module of claim 13, wherein said box can be 50 mm (L)×25 mm (W)×20 mm (H) or smaller.

15. The small ozone generator module of claim 11, wherein said input power of the positive and negative wires can vary within a range of 5˜12 volts.
